(19) United States
(12) Patent Application Publication
(10) Pub. No.: US 2003/0047503 A1
(43) Pub. Date: Mar. 13, 2003

(54) Filter element with foam girdle to secure pleats

(76) Inventors: Christhoper B. Bortnik, Warrendale, PA (US); Alexander Kiderman, Pittsburgh, PA (US)

Correspondence Address: David C Hanson, 700 Koppers Building, 436 Seventh Avenue, Pittsburgh, PA, 15219-1818, US

(21) Appl. No.: 10/257,171

(22) PCT Filed: May 3, 2001
(86) PCT No.: PCT/US01/14352

(51) Int. Cl. B01D 27/06

(52) U.S. Cl. 210/315; 210/489; 210/493.1

(57) ABSTRACT

A filter element (10) comprises a pleated filter media (34) having spaced apart pleats (40) and an external filter media surface (38) comprising the external peaks of the pleats (40) and a flexible foam filter media sleeve (42) in contact with the external filter media surface (38). The filter media sleeve (42) maintains the spacing between the external peaks of the pleats (40) of the pleated filter media (34).

### BACKGROUND OF THE INVENTION

1. Field of the Invention

The present invention relates to filter elements and, more particularly, to standard and coreless filter elements having pleated filters.

2. Brief Description of the Prior Art

Fluid systems often include an in-line filtration system for filtering out particles or other impurities in the fluid. The in-line filtration systems generally include a housing forming a hollow center chamber, a fluid inlet port, and a fluid outlet port. A replaceable filter element, usually forming a plurality of pleats, is positioned inside the hollow center chamber of the housing. An example of such a pleated element is disclosed in U.S. Pat. No. 3,552,553 to Redding. The fluid enters the inlet port of the filter, which is generally positioned at an outer edge of the housing, flows through the replaceable filter element, and exits the outlet port which is usually positioned adjacent a center portion of the housing.

One drawback of filters having pleated filtering elements is that the spacing of each individual pleat can vary as the differential pressure of the fluid passing through the pleats is increased. Upon filtration of high viscosity oil, for example at cold start-up, the pleats may move toward one another causing bunching which restricts the flow of fluid flowing through the filter and also decreases the effectiveness of the filter.

One approach to overcoming this problem is disclosed in PCT application WO 97/31695. That application discloses using a spun-bonded support disposed within a cylindrical, internal cavity formed by a pleated filter element. Internal peaks of the filter element, formed by the pleats, are glued to the support wrap to increase the stability of the filter element and maintain separation of the pleats. One drawback of that approach is the manufacturing and material costs associated with accurately fixing the internal peaks of the pleats to the support wrap such that the pleats are evenly spaced.

### SUMMARY OF THE INVENTION

The present invention provides a filter element generally including a pleated filter media forming an external media surface comprised of the external pleat peaks with each filter pleat being fixed spaced apart from a neighboring pleat. A filter media sleeve is positioned adjacent the external media surface of the filter media, wherein the filter media sleeve is in contact with the external filter media surface to maintain the separation between each pleat.

The filter element according to the present invention may be manufactured by positioning the filter media sleeve adjacent to the external filter media surface and then compressing the filter media sleeve partially into indentations formed between each pleat of the filter media. Alternatively, the filter media sleeves can be preformed with ridges and valleys that correspond to opposing ridges and valleys in the external filter media surface of the filter media.

These and other advantages of the present invention will be clarified in the description of the preferred embodiment taken together with the attached drawing.

### BRIEF DESCRIPTION OF THE DRAWING

FIG. 1 is an exploded view of one embodiment of the present invention.

### DETAILED DESCRIPTION OF THE PREFERRED EMBODIMENT

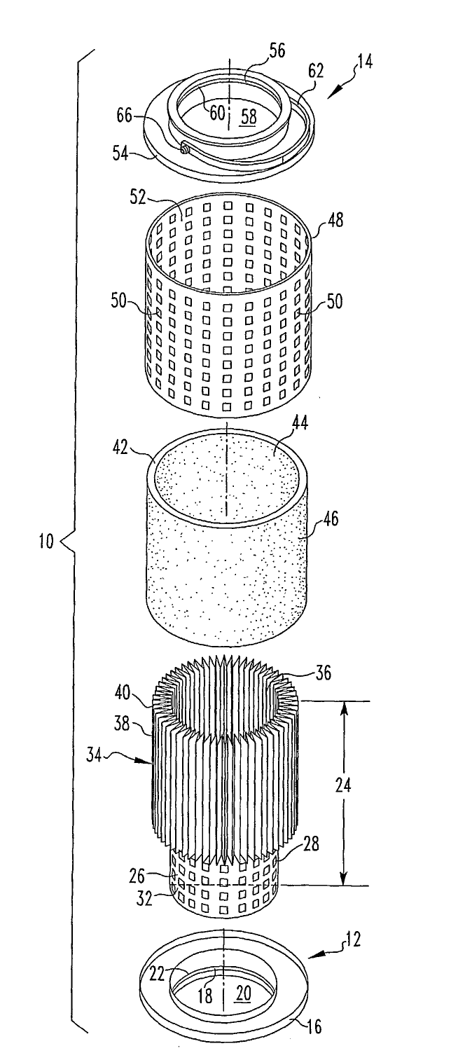

The preferred embodiment of the present invention is generally shown in FIG. 1 showing a filter 10 having a first end 12 and a second end 14. A first end cap 16 is positioned adjacent the first end 12 of the filter 10. The first end cap 16 is provided with a groove 18 in the interior surface of hollow cylindrical cavity 20. An O-ring 22 is received in the groove 18 of the first end cap 16.

A filter assembly 24 is positioned adjacent the first end cap 16. The filter assembly 24 generally includes a hollow perforated tube 26 with perforations 28 formed therethrough, an internal tubing surface, an external tubing surface 32, and a pleated filter media 34. The tube 26 is preferably formed from polypropylene, nylon, or other suitable material. The pleated filter media 34, having an internal filter media surface 36 comprising internal pleat peaks and an external filter media surface 38 comprising external pleat peaks, is positioned with the internal media surface 36 adjacent the external tube surface 32 of the tube 26. The internal filter media surface 36 and the external filter media surface 38 bound a plurality of individual pleats 40. The peaks of each pleat 40 are preferably spaced from peaks of a neighboring pleat 40 by a uniform distance. The pleated filter media 34 is preferably formed from cellulose, glass, or other suitable material.

A filter media sleeve 42, having an internal sleeve surface 44 and an external sleeve surface 46, is positioned adjacent the external filter media surface 38 of the pleated filter media 34. The filter media sleeve 42 is preferably formed from reticulated flexible ether foam, approximately 0.16 cm to 2.5 cm thick T. However, the thickness can be increased or decreased depending on the size or application of the filter 10. One such foam is sold under the SIF trademark and is available commercially from Foamex International Inc., 1000 Columbia Avenue, Linwood, Pa. 19061. It is a reticulated flexible polyurethane foam, characterized by a three-dimensional skeletal structure of strands which provide void space. With controlled pore sizes ranging from 1 pore per linear cm to 50 pores per linear cm, it offers uniformity.

The internal sleeve surface 44 of the filter media sleeve 42 is in direct physical contact with the external filter media surface 38 of the pleated filter media 34. A support sleeve 48, preferably formed from polypropylene, nylon, or other suitable material, may be used to hold the filter media sleeve 42 in constant contact with the external filter media surface 38 of pleated filter media 34. The support sleeve 48 is provided with a plurality of orifices 50 and an internal support sleeve surface 52.

A second end cap 54 is positioned adjacent the second end 14 of the filter 10 with the second end cap 54 provided with a groove 56 in the interior cylindrical surface in the hollow cylindrical cavity 58, wherein an O-ring 60 is received in the groove 56. The O-rings 22, 60 are preferably formed from rubber, synthetic rubber, nylon, or other suitable material. A handle 62 is attached to the second end cap 54 by pins 66.

The filter media sleeve 42 can be preformed with ridges and indentations that correspond to the external peaks of the pleats 40 of the pleated filter media 34. Alternatively, the filter media sleeve 42 can be wrapped around or positioned adjacent pleated filter media 34 and compressed by the support sleeve 48 partially into the spaces formed between the pleats 40.

It has been found that positioning the filter media sleeve 42 in direct contact with the external surface of the pleated filter media 34, without adhesive, keeps the pleats 40 from bunching together during flow of a fluid through the pleated filter media 34. This antibunching effect helps prevent flow resistance exerted on the fluid during movement through the pleated filter media 34.

Having thus described our invention with the detail and particularity required by the Patent Laws, what is desired protected by Letters Patent is set forth in the following claims.

We claim:

1. A filter element comprising:
pleated filter media having spaced apart pleats and an external filter media surface comprising the external peaks of the pleats; and
a flexible foam filter media sleeve in contact with the external filter media surface, and extending at least partially into the spaces between the peaks of the pleats, wherein the filter media sleeve maintains the space between the external peaks of the pleats of the filter media.

2. A method of producing a filter as described in claim 1, comprising:
preforming a filter media sleeve with ridges that correspond to external peaks of the filter media surface.

3. A method of producing a filter as described in claim 1, further comprising the step of:
positioning a filter media sleeve adjacent the external peaks at the external filter media surface of a pleated filter media, wherein the filter media sleeve maintains the spacing between each of the external peaks.

4. A method of making a pleated filter element comprising:
arranging a pleated filter media into a cylindrical shape having external pleat peaks and internal pleat peaks; and
placing a foam filter media sleeve in contact with the external pleat peaks.

5. The method of claim 4, comprising:
preforming a filter media sleeve with ridges that correspond to external peaks of the filter media surface.

6. The method of claim 4, comprising:
positioning a filter media sleeve adjacent the external peaks at the external filter media surface of a pleated filter media, wherein the filter media sleeve maintains the spacing between each of the external peaks.
